(19) United States
(12) Patent Application Publication
(10) Pub. No.: US 2019/0078371 A1
(43) Pub. Date: Mar. 14, 2019

(54) METHOD FOR DISPLACING A SIDE DOOR OF A MOTOR VEHICLE, ASSOCIATED PINCH PROTECTION SENSOR, MOTOR VEHICLE, AND METHOD OF OPERATING THE PINCH PROTECTION SENSOR

(71) Applicant: BROSE FAHRZEUGTEILE GMBH & CO. KOMMANDITGESELLSCHAFT, BAMBERG, BAMBERG (DE)

(72) Inventors: FLORIAN POHL, EBERSDORF (DE); CHRISTIAN HERRMANN, COBURG (DE)

(21) Appl. No.: 16/128,737

(22) Filed: Sep. 12, 2018

(30) Foreign Application Priority Data
Sep. 12, 2017 (DE) 10 2017 216 115.9

(51) Int. Cl. E05F 15/46; E05F 15/76

(52) U.S. Cl. CPC E05F 15/46; E05Y 2900/531; E05F 15/76

(57) ABSTRACT

A method displaces a side door of a motor vehicle which can be locked in a completely or partially open state by a self-inhibiting drive and/or by a brake and which is provided with a pinch protection sensor that is arranged at least partly on its closing edge. It is detected by use of the pinch protection sensor whether the closing edge is gripped by a hand. If necessary, the locking of the side door by the drive and/or brake is suspended or relaxed in order to permit the side door to be displaced manually.

### CROSS-REFERENCE TO RELATED APPLICATION

This application claims the priority, under 35 U.S.C. § 119, of German application DE 10 2017 216 115.9, filed Sep. 12, 2017; the prior application is herewith incorporated by reference in its entirety.

### BACKGROUND OF THE INVENTION

### Field of the Invention

The invention relates to a method for displacing a side door of a motor vehicle, which can be locked in a completely or partially open state by a self-inhibiting drive and/or by a brake and which is provided with a pinch protection sensor that is arranged at least partly on its closing edge. The invention further relates to a pinch protection sensor that is arranged at least partly on a closing edge of a side door of a motor vehicle. Moreover, the invention also relates to a motor vehicle having a side door and a pinch protection sensor that is attached at least partly to the motor vehicle and also relates to a use of a pinch protection sensor such as this.

When motor vehicle doors are closing, the risk regularly arises that objects or body parts of a vehicle user will be pinched between a closing edge of the side door and the vehicle body. This can result in an injury to the pinched vehicle user or damage to the motor vehicle or the pinched object. This risk is especially great in the case of side doors that are displaced by an externally powered drive.

To prevent injuries and damage caused by pinching incidents of this type, a vehicle door of a modern motor vehicle is often provided with a pinch protection mechanism, which detects a pinching incident that is about to happen or has already occurred when closing the respective vehicle door and, if possible, halts or reverses the movement of the vehicle door.

A differentiation is made between direct and indirect pinch protection mechanisms. An indirect pinch protection mechanism monitors the closing movement of the vehicle door or a correlated operating parameter of a door drive, such as the speed or torque of an electrical driving motor, and detects the pinching incident that has already occurred on the basis of abnormal behavior in the closing movement and/or the monitored operating parameter, e.g. an unexpected decline in the motor speed. Direct pinch protection mechanisms, on the other hand, directly detect an obstacle in the displacement path of the closing vehicle door, in particular a body part or an object, by use of suitable sensors.

Direct pinch protection mechanisms such as this can be further divided on the one hand into tactile pinch protection mechanisms, which detect the obstacle only when it is already touching the closing edge of the vehicle door and/or the opposite closing edge of the vehicle body, and on the other hand into contactless pinch protection mechanisms, which already detect the obstacle at a particular distance from the sensor of the pinch protection mechanism. Capacitive proximity sensors are commonly used as contactless pinch protection mechanisms, after all.

A capacitive proximity sensor normally contains at least one sensor electrode, by which an electric field is generated in an upstream spatial volume. The sensor electrode thus forms an electrical capacitor to ground or to a further sensor electrode, and the capacitance of the capacitor is measured directly or indirectly by a control system of the proximity sensor. The operating principle of a capacitive proximity sensor is based on the physical effect that the electric field emitted by the sensor electrode interacts with objects and especially body parts in the immediate vicinity of the sensor electrode, as a result of which the measured capacitance is influenced in a characteristic way.

Concretely, a capacitive proximity sensor often functions according to one of two operating principles, which will hereafter be called the “single-electrode principle” and “transceiver principle”.

A proximity sensor operating according to the “transceiver principle” contains at least two sensor electrodes, namely a transmitting electrode and a receiving electrode. In this case, the control system of the proximity sensor activates the transmitting electrode by applying an electrical alternating voltage to generate the electric field. At the same time, the control system measures the electrode current at the receiving electrode, which is induced under the effect of this electric field, as a measure of the capacity of the capacitor that is formed between the transmitting electrode and the receiving electrode.

By contrast, a proximity sensor functioning according to the “single-electrode principle” includes only one sensor electrode or multiple sensor electrodes of the same type (i.e. not differentiated into transmitting or receiving electrodes). A field-generating signal in the form of an electrical alternating voltage is applied to the or each sensor electrode by the control system, and so the sensor electrode creates an electric field relative to ground (such as a grounded vehicle part). At the same time, the control system measures the electrode current, which is flowing to or from this sensor electrode under the effect of the alternating voltage, as a measure of the electrical capacity of the capacitor that is formed between the respective sensor electrode and the ground.

The drives employed for the automatic displacement of a motor vehicle side door are often configured to be self-inhibiting, and so they lock the associated side door in the respective current position when in the deactivated state. Alternatively or additionally, a motor vehicle side door sometimes has a brake associated with it, which likewise causes the side door to be locked in a completely or partially open state. Locking the side door offers the advantage that the side door cannot automatically be set into motion by undesired external forces, such as wind, and thus possibly cause damage. However, locking the door disadvantageously compromises user comfort, especially since a user cannot simply close the open side door by hand if necessary. Although it would be possible to provide dedicated actuation elements to suspend the locking, they would appreciably complicate rather than simplify the handling of the vehicle door—particularly for a vehicle user who was not familiar with the details of the door function. In addition, actuation elements such as these would also unfavorably increase the manufacturing costs for the motor vehicle.

### SUMMARY OF THE INVENTION

The invention addresses the problem of facilitating the displacement of a motor vehicle side door of the type described above in a manner that is simple to implement. On the one hand, it should be possible in particular to lock the side door in a completely or partially open state by an associated drive and/or an associated brake. At the same time, however, it should also be possible to displace (especially close) the side door in an intuitively executable way and without exerting a large amount of force as required.

With regard to a method for displacing a side door of a motor vehicle, this problem is solved according to the invention by the features of the main method claim. With regard to a pinch protection sensor that is to be arranged at least partly on a closing edge of a motor vehicle side door, the problem is solved according to the invention by the features of the main apparatus claim.

Advantageous embodiments and developments of the invention, some of which are inventive per se, are found in the sub-claims and the description that follows.

The invention proceeds from a side door of a motor vehicle, which, during normal operation, is locked in a completely or partially open state by a self-inhibiting drive and/or by a brake and which is provided with a pinch protection sensor that is arranged at least partly on the closing edge of the side door.

Here a “closing edge” is considered to be that edge of the side door that lies directly against, or a short distance from, a corresponding closing edge of the vehicle body when the side door is in the closed state. The corresponding closing edges of the vehicle door and the vehicle body thereby form—as viewed from outside the vehicle—the boundary line, which delimits the closed side door from the surrounding vehicle body.

The pinch protection sensor is a direct pinch protection mechanism in the sense of the definition provided above. Accordingly, the pinch protection sensor detects whether an obstacle is located in the displacement path of the side door (i.e. in the spatial area through which the side door passes while closing), wherein the pinch protection sensor stops or reverses the movement of the side door when necessary by activating the drive and/or the brake.

According to the invention, beyond this usual pinch protection function, the pinch protection sensor is also granted an additional function, in which it can be detected by means of the pinch protection sensor whether the closing edge of the side door is gripped by the hand of a user. If necessary (in other words, when the pinch protection sensor detects the hand gripping the closing edge), the locking of the side door brought about by the drive and/or brake is suspended (deactivated) or relaxed (partially suspended, i.e. set in a state with reduced locking force) by the pinch protection sensor in order to permit a manual displacement (i.e. closing or opening) of the side door, without the full inhibiting or blocking effect of the drive or brake having to be overcome. If the locking effect of the drive and/or brake is not completely suspended upon detection of the hand gripping the closing edge but is instead only relaxed, then the reduced locking force that remains is preferably selected in such a way that, on the one hand, it opposes the manual displacement of the door with palpable but easily overcome resistance but, on the other hand, under normal circumstances prevents an automatic displacement of the door.

In other words, the pinch protection sensor can be operated in two different operating modes, namely a pinch protection mode and a grip detection mode.

Within the framework of the invention, the pinch protection sensor can basically be a tactile sensor that detects the pinching incident only upon contact with the sensor. Preferably, though, a contactless pinch protection sensor is used, which already detects an obstacle at a distance as a possible cause for an impending pinching incident. Nevertheless, however, the pinch protection sensor in both cases is preferably configured such that, when in the grip detection mode, it detects the hand gripping the closing edge only when the hand touches the proximity sensor. In a proximity sensor that functions contactlessly per se, this is preferably achieved in that a prescribed trigger threshold for the detection of the hand gripping the closing edge is selected to be correspondingly higher than a trigger threshold for the contactless detection of an impending pinching incident. Alternatively, the pinch protection sensor also has a tactile detection function in addition to the contactless detection function (and independently of it). For example, in one practical embodiment the pinch protection sensor is configured as a capacitive proximity sensor with two sensor electrodes that are disposed at a distance from each other in the resting state, wherein the sensor electrodes for the tactile detection of the hand gripping the closing edge can be brought into electrically conductive contact with each other such that the short circuit that is thereby formed between the sensor electrodes indicates contact with the sensor electrode.

If the locking of the side door is carried out by a brake, then this brake is advantageously released completely or partially so as to suspend and/or relax the locking by the pinch protection sensor when the sensor detects the hand gripping the closing edge. By contrast, if the side door is locked by the self-inhibiting effect of the drive that may be associated with it, then a clutch, that is interposed between the drive and the side door, is preferably completely or partly released so as to suspend and/or relax this locking. In one advantageous alternative configuration, the drive is actuated by the pinch protection sensor when it detects the hand gripping the closing edge so as to suspend and/or relax the locking of the door in such a way that the drive enhances a force that is manually exerted upon the side door. Thus the drive is operated in this function purely as an auxiliary drive (somewhat similar to power steering).

The pinch protection sensor is operated in the pinch protection mode in particular when the side door is being moved toward its closed position under external power (i.e. by the drive that may be associated with it). In the grip detection mode, by contrast, the pinch protection sensor is preferably always operated when the side door is locked in the completely or partially open state by the deactivated drive and/or brake.

When the pinch protection sensor has detected the hand gripping the closing edge, the grip detection mode is nevertheless maintained as long as the hand is left on the closing edge—including when the door is being moved toward its closed position by the exertion of manual force. In this configuration, the pinch protection sensor thus monitors how long the closing edge of the side door is gripped by the hand and maintains the locking of the side door in the deactivated state preferably for this entire span of time, expediently including a prescribed follow-up time. In this way, the side door can be prevented from being locked again during manual closing. The effect of the follow-up time is that the side door can be released before reaching the closed state without the locking function being activated.

In order to avoid an unintentional suspension and/or relaxing of the locking, it is provided in one practical embodiment of the invention that, upon a detection of the hand gripping the closing edge by the pinch protection sensor, the locking of the side door is suspended only when the gripping of the closing edge is detected for longer than a predetermined standby time. In embodiments of the invention in which the grip detection is not continuous but cyclically discontinuous, the locking of the side door is suspended and/or relaxed in particular only when the hand gripping the closing edge is detected for multiple directly consecutive detection cycles. On the other hand, when the closing edge is gripped for a short time that does not exceed the standby time or the prescribed number of detection cycles, the locking is preferably not suspended or relaxed.

In one advantageous embodiment of the invention, the pinch protection sensor is configured to detect in a spatially resolved manner the location at which the closing edge is gripped by the hand. For example, the pinch protection sensor is thus divided into a plurality of longitudinal segments, which detect the gripping of the closing edge independently of one another. In a pinch protection sensor such as this, which detects in a spatially resolved manner, the locking of the side door is preferably suspended or relaxed only in cases when the gripping is detected in a predetermined section of the closing edge. Optionally, when it detects gripping in a different section of the closing edge, the pinch protection sensor triggers a different operating command, e.g. the automatic closure of the side door by the associated drive. In this respect, for instance, the pinch protection sensor completely or partially suspends the locking of the side door for the manual closing only when it detects the gripping of the closing edge at a medium door height (approximately in the region of the lower edge of the window), whereas the pinch protection sensor permits the automatic closing of the vehicle door when it detects a brief gripping of the side door in the region of the upper side of the door.

The invention is preferably used on a motor vehicle side door that is pivotably mounted on the vehicle body of the motor vehicle. Furthermore, the invention can also be used on a sliding side door. In both cases, the side door can preferably be displaced continuously between a closed position and a maximum open position.

Preferably, a capacitive proximity sensor is used as a pinch protection sensor, which functions in particular according to one of the two operating principles mentioned above, namely the “single-electrode principle” or the “transceiver principle”.

The pinch protection sensor according to the invention is generally configured for automatically performing the method according to the invention. In this regard, advantageous embodiment variants of the method correspond to relevant embodiment variants of the pinch protection sensor according to the invention.

The pinch protection sensor in this instance—as was mentioned—is configured in particular as a capacitive proximity sensor. The pinch protection sensor here preferably has at least one elongate sensor electrode to be arranged along the closing edge of the side door and a control system (which is integrated into the sensor electrode or is spatially separate from it). The control system is configured to record a measurement signal that is characteristic for the capacitance to ground of the sensor electrode or for a further sensor electrode in a pinch protection mode, and, on the basis of this measurement signal, to detect an obstacle preventing the closing of the side door. The control system is further designed to stop or reverse a closing movement of the side door, if necessary (i.e. if any such obstacles are detected), by activating a drive or a brake.

Another embodiment of the invention is a motor vehicle having a side door and the pinch protection sensor according to the invention, which is at least partially attached to the motor vehicle. Finally, yet another embodiment of the invention is also the use of a suitable pinch protection sensor, which is at least partly arranged on a closing edge of a side door of a motor vehicle, to detect whether the closing edge is gripped by a hand of a vehicle user and to suspend or relax a locking of the completely or partially open side door brought about by a drive and/or brake upon detection of the hand gripping the closing edge so that the side door can be displaced (i.e. closed or opened) manually.

The invention is especially advantageous when employed in a motor vehicle whose side doors—e.g. for reasons of design—do not have an exterior handle, and which are therefore regularly gripped on the closing edge for manual opening and closing.

Other features which are considered as characteristic for the invention are set forth in the appended claims.

Although the invention is illustrated and described herein as embodied in a method for displacing a side door of a motor vehicle and an associated pinch protection sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic detail, top view of a motor vehicle from above, with two side doors that are pivotably mounted on a vehicle body, of which the rear side door is exemplarily shown with solid lines in a partially open state, with dashed lines in a completely open state and with dot-dashed lines in a closed state;

FIG. 2 is a schematic side view of the motor vehicle according to FIG. 1;

FIG. 3 is a side view according to FIG. 2 of the motor vehicle in an alternative embodiment; and

FIG. 4 is a side view according to FIG. 2 if the motor vehicle in a further embodiment.

### DETAILED DESCRIPTION OF THE INVENTION

Correlating parts and sizes are always provided with the same reference signs in all drawings.

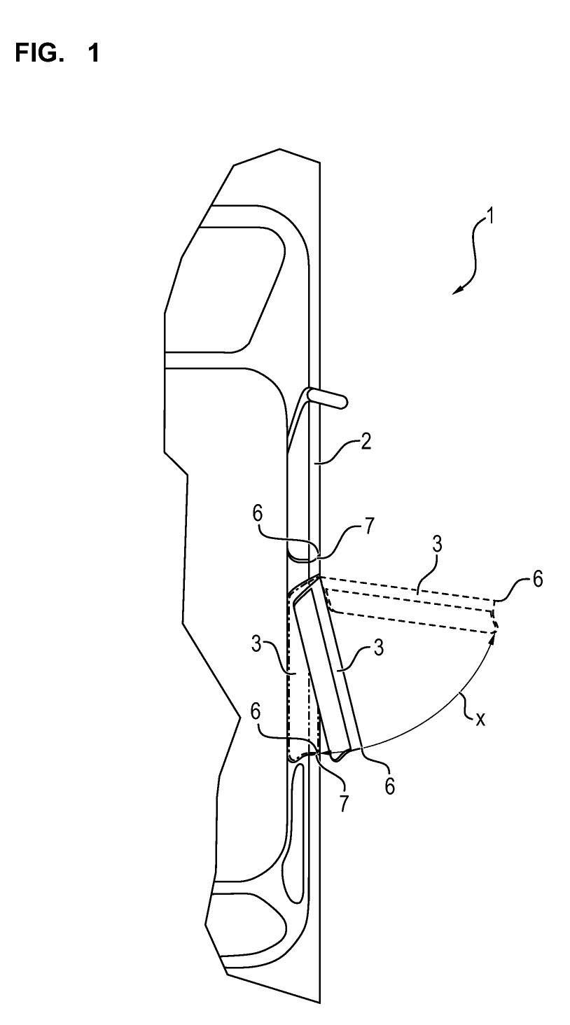

Referring now to the figures of the drawings in detail and first, particularly to FIG. 1 thereof, there is shown a motor vehicle 1 which has a front side door 2 and a rear side door 3 on each longitudinal side. In the representation according to FIG. 1, the front side door 2 on the right side of the vehicle as represented here is shown exemplarily in the closed state, whereas the rear side door 3 is pictured
a) with solid lines in a partially open state,
b) with dashed lines in a completely open state, and
c) with dot-dashed lines in a closed state.

Each of the vehicle doors 2, 3 is mounted on a vehicle body of the motor vehicle 1 such that it can be reversibly pivoted between the closed state and the completely open state and traverses a displacement path X indicated in FIG. 1 when it pivots between these states.

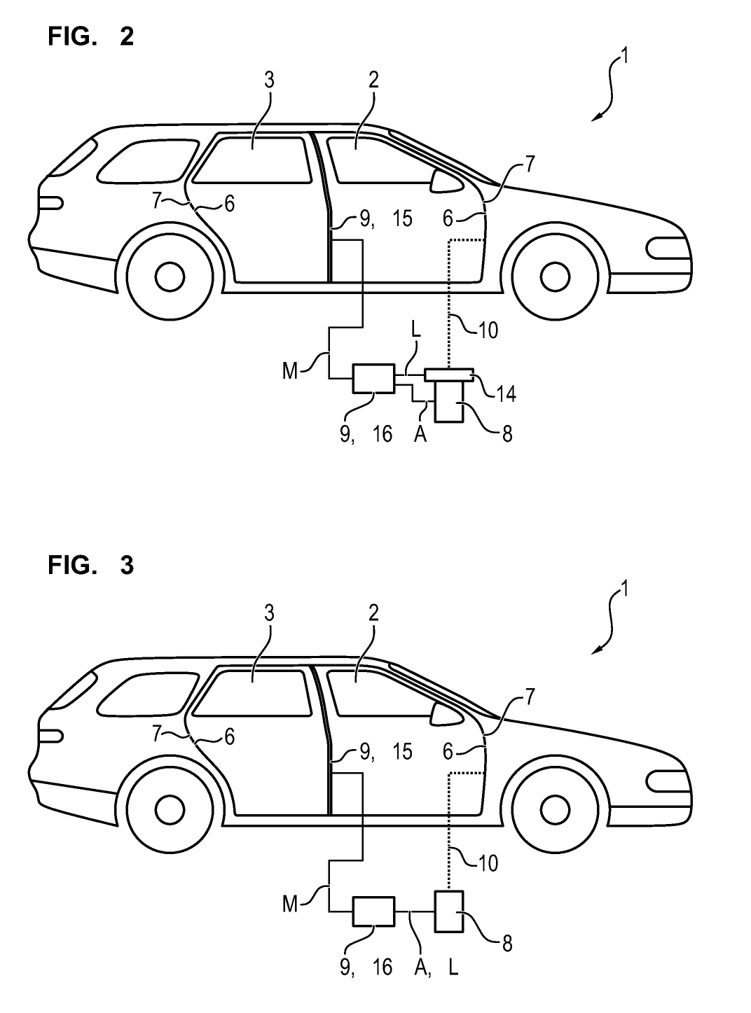

Each of the two side doors 2 and 3 has a circumferential closing edge 6, which abuts a corresponding closing edge 7 of the vehicle body when the respective side door 2, 3 is in the closed state. As viewed from outside, the corresponding closing edges 6 and 7 thus form the boundary line, by which each respective side door 2, 3 is delimited from the surrounding vehicle body when in its closed state (see FIGS. 2 through 4).

As is indicated in FIG. 2, a drive 8 is associated with each of the two side doors 2 and 3. Moreover, a pinch protection sensor 9 is associated with each of the side doors 2, 3. Simply for reasons of better visibility, the drive 8 and the pinch protection sensor 9 are shown partially outside of the motor vehicle 1 in the schematic representation according to FIG. 2. In the practical embodiment, however, the drive 8 and the pinch protection sensor 9 are preferably installed in the respective side door 2 and 3. The side doors 2 and 3 of the left side of the vehicle, which is not shown in the drawings, are preferably constructed identically to the side doors 2 and 3 on the right side of the vehicle and, accordingly, are likewise provided with a drive 8 and a pinch protection sensor 9.

The drive 8 acts upon the respective side door 2, 3 via an adjustment mechanism 10, and so the side door 2, 3 can be displaced along displacement path X by external power (i.e. without the exertion of manual force). The drive 8 is preferably formed by an electric motor with a self-inhibiting drive that is disposed upstream (e.g. in the form of a worm gear). By contrast, the adjustment mechanism 10 is freewheeling (not self-inhibiting). A clutch 14 is interposed between the drive 8 and the adjustment mechanism 10, by which the drive 8 and adjustment mechanism 10 can be reversibly drivingly coupled and separated from each other.

During normal operation of the vehicle, the adjustment mechanism 10 is coupled with the drive 8. In this state, the self-inhibiting reduction gear of drive 8 prevents a force acting upon the respective side door 2, 3 from being able to rebound on the electric motor and cause a rotation of the motor shaft. The side door 2, 3 is thus locked in its current position when the drive 8 is deactivated. When the clutch 14 is released, the adjustment mechanism 10 and the connected side door 2, 3 are decoupled from the drive 8, and so the side door 2, 3 can be displaced independently of the drive 8 by exerting manual force.

The pinch protection sensor 9 is configured as a capacitive proximity sensor and has an elongate sensor electrode 15 and an associated control system 16. The sensor electrode 15—as is indicated in FIG. 2—is arranged on the respective side door 2, 3 in such a way that it flanks the closing edge 6 of the side door 2, 3 on the inner side of the door (over the entire length of the closing edge 6 or a segment thereof) at a short distance of e.g. 1 cm. In the schematically simplified FIG. 2, the sensor electrode 15 coincides with the closing edge 6 as a function of the drawing.

The sensor electrode 15 is thus arranged on the closing edge 6 of the respective side door 2, 3 in such a way that it is necessarily touched by a vehicle user's hand when the hand grips the closing edge 6 in the completely or partially open state of the side door 2, 3.

In one preferred embodiment, the control system 16 contains driver electronics for activating the sensor electrode 15 with a field-generating electric alternating signal as well as a microcontroller, which activates the driver electronics in accordance with a control program (firmware). Alternatively, the control system 16 is formed by a non-programmable control logic, such as in the form of a so-called ASIC. The pinch protection sensor 9 preferably functions according to the aforementioned single-electrode principle.

According to the control program or the circuit logic, the pinch protection sensor 9 can be operated in two different operating modes, namely a pinch protection mode and a grip detection mode.

In the pinch protection mode, the pinch protection sensor 9 is always operated when and as long as the drive 8 is displacing the side door 2, 3 in the closing direction. In this process, the control system 16 applies an electric alternating signal to the sensor electrode 15, under the effect of which the sensor electrode 15 generates an electrical field in the displacement path X of the vehicle door 2, 3 (thus in particular in the spatial area formed between the closing edges 6 and 7). The control system 16 then measures the electrode current flowing to the sensor electrode 15 and/or from the sensor electrode 15 as measurement signal M, which is characteristic for the capacitance of the capacitor that is formed between the sensor electrode 15 and ground.

The control system 16 compares this measurement signal M with a saved first threshold value. The first threshold value (which preferably varies according to a pre-set characteristic curve as a function of the door position) is predetermined such that it is exceeded when a human hand or a comparable object approaches to a predetermined distance of e.g. 5 cm from the sensor electrode 15. The control system 16 recognizes the instance of the threshold value being exceeded as an indication of an impending pinching incident. Accordingly, when the first threshold value is exceeded, the control system 16 sends a cancel signal A to the drive 8, on the basis of which the drive 8 is deactivated to stop the movement of the door.

In the grip detection mode, the control system 16 drives the sensor electrode 15 basically in the same way as in the pinch protection mode, and it likewise records the electrode current as a measurement signal M. However, in the grip detection mode, the control system 16 compares the measurement signal M with a second threshold value, which is selected to be different from the first threshold value in such a way that it is exceeded only when a human hand directly touches the sensor electrode 15. The control system 16 accordingly detects an exceedance of the second threshold value as an indication that the closing edge 7 of the respective side door 2, 3 is being gripped by the hand of a vehicle user. In this case, the control device 16 sends a release signal L to the clutch 14, on the basis of which the clutch 14 is released to decouple the adjustment mechanism 10 from the drive 8. In one preferred embodiment, however, the control device 16 does not send the release signal until the second threshold value has been exceeded continuously for more than a predetermined standby time, such as 1 second.

The control system 16 maintains the release signal L for beyond the amount of time for which the threshold value is exceeded until the end of a predetermined standby time of, for example, 5 seconds. This makes it possible for the vehicle user to move the side door 2, 3 freely as long as he or she is gripping the closing edge 7 and for him or her to release the grip in a timely manner before the side door 2, 3 reaches its closed position, without the side door 2, 3 being locked again.

When the side door 2, 3 is in the closed state and during an opening movement, the pinch protection sensor 9 is preferably not operated in either of the two operating modes described above. Instead, the pinch protection sensor is preferably deactivated in these cases.

In the embodiment according to FIG. 3, on the other hand, the drive 8 is configured to be self-inhibiting. However, it remains fixedly coupled to the adjustment mechanism 10 without an interposed clutch 14. In order to permit the side door 2, 3 to nevertheless be closed by the exertion of manual force, the drive 8 in this instance is operated as an auxiliary drive, which supports and enhances a force exerted manually upon the side door 2, 3, as soon and as long as the control system 16 identifies the gripping of the closing edge 7. To this end, the control system transmits the release signal L to the drive 8.

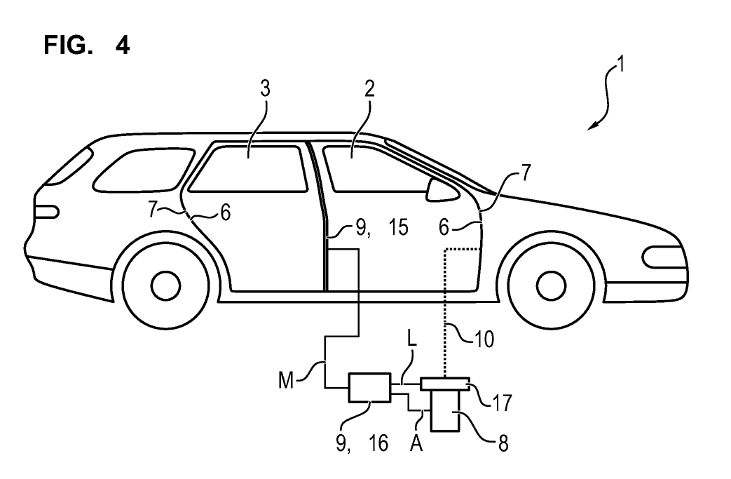

The exemplary embodiment shown in FIG. 4 differs from the exemplary embodiment according to FIG. 2 in that the adjustment mechanism 10 and the drive 8 here are continuously free-wheeling (i.e. not self-inhibiting). As a result, the side door 2, 3 could basically also be moved when the drive 8 is deactivated under the effect of external force (for example, by the hand of a vehicle user or by the wind). In order to nevertheless prevent an unintended movement of the door, a brake 17 that locks the side door 2, 3 in a completely or partially open state when the drive 8 is deactivated is therefore interposed between the adjustment mechanism 10 and the drive. In this case, the control system 16 of the pinch protection sensor 9 sends the release signal L to the brake 17, which thereupon is released and thus permits a manual displacement of the side door 2, 3.

In the exemplary embodiments according to FIGS. 3 and 4, as well, each of the side doors 2, 3 of the motor vehicle 1 is preferably provided with the drive 8 and the pinch protection sensor 9.

The invention becomes particularly clear on the basis of the exemplary embodiments described above, but is nevertheless not limited to these exemplary embodiments. Rather, numerous other embodiments of the invention can be derived from the claims and the description by a person skilled in the art. In particular, the sensor electrode 15 can also be divided into multiple independently sensing longitudinal segments in all of the exemplary embodiments described above, and so the control system 16 detects the position in which the closing edge 7 is gripped in a spatially resolved manner. Here the control system 16 preferably suspends the locking of the side door only when the closing edge 7 is gripped in a predetermined region, such as on the opening side of the respective side door 2, 3 approximately at medium door height; in other words, in the area of the lower edge of the door window. Gripping the closing edge 7 in an area other than this, such as in an upper region of the respective side door 2, 3 when the side door 2, 3 is open and stationary either has no effect or triggers a different reaction by the control system 16. For example, the control system 16 is configured such that it induces an automatic closing of the side door 2, 3 by a corresponding activation of the drive 8 when the vehicle user grips the upper region of the closing edge 7 briefly. Optionally, further sensors can be provided in the motor vehicle 1, by interacting with which it is likewise possible to suspend the locking of a respectively associated side door 2, 3. Sensors such as these can be disposed, for example, on the B pillar of the motor vehicle 1 or on the inner side of the door, such as in the vicinity of the map pocket or inside handle. Moreover, the pinch protection sensor 9 can also be configured to recognize hand movements (swiping gestures) past the sensor electrode 15 and to trigger associated control commands (such as an automatic displacement of the respective side door 2, 3).

The following is a summary list of reference numerals and the corresponding structure used in the above description of the invention:
1 Motor vehicle
2 (Front) side door
3 (Rear) side door
6 Closing edge (of the side door)
7 Closing edge (of the vehicle body)
8 Drive
9 Pinch protection sensor
10 Adjustment mechanism
14 Clutch
15 Sensor electrode
16 Control system
17 Brake
A Cancel signal
L Release signal
M Measurement signal
X Displacement path

1. A method for displacing a side door of a motor vehicle, the side door being lockable in a completely or partially open state by means of a self-inhibiting drive and/or by means of a brake, the side door having a pinch protection sensor that is disposed at least partly on a closing edge of the side door, which comprises the steps of:
detecting, by means of the pinch protection sensor, whether the closing edge is gripped by a hand; and
suspending or relaxing a locking of the side door by the self-inhibiting drive and/or the brake in order to permit the side door to be displaced manually.

2. The method according to claim 1, which further comprises completely or partially releasing a clutch that is interposed between the self-inhibiting drive and the side door upon detection of the hand gripping the closing edge so as to suspend the locking.

3. The method according to claim 1, which further comprises actuating the self-inhibiting drive upon detection of the hand gripping the closing edge so as to suspend the locking in such a way that the self-inhibiting drive enhances a force that is manually exerted upon the side door.

4. The method according to claim 1, wherein the pinch protection sensor always detects whether the closing edge is gripped by the hand when the side door is locked by the self-inhibiting drive and/or the brake in the completely or partially open state.

5. The method according to claim 1, which further comprises suspending, upon detection of the hand gripping the closing edge, the locking of the side door only when the gripping of the closing edge is detected for longer than a predetermined standby time.

6. The method according to claim 1, wherein the pinch protection sensor detects in a spatially resolved manner a location at which the closing edge is gripped by the hand, and wherein the locking of the side door is suspended or relaxed only in cases when a gripping is detected in a predetermined section of the closing edge.

7. The method according to claim 1, wherein the side door is pivotably mounted on a vehicle body of the motor vehicle.

8. The method according to claim 1, which further comprises configuring the pinch protection sensor for a contactless detection of an obstacle in a displacement path of the side door.

9. The method according to claim 1, which further comprises configuring the pinch protection sensor as a capacitive proximity sensor.

10. A pinch protection sensor that is to be disposed at least partly on a closing edge of a side door of a motor vehicle, the pinch protection sensor comprising:
a controller programmed to:
detect whether the closing edge is gripped by a hand; and
suspend or relax a locking of the side door by a drive and/or a brake of the motor vehicle in order to permit the side door to be displaced manually.

11. The pinch protection sensor according to claim 10,
further comprising at least one elongated sensor electrode disposed along the closing edge of the side door; and
wherein said controller is configured to detect an obstacle preventing a closing of the side door by recording a measurement signal that is characteristic for a capacitance to ground of said elongated sensor electrode or for a further electrode.

12. A motor vehicle, comprising:
a drive;
a brake;
a side door having a closing edge;
a pinch protection sensor disposed at least partly on said closing edge of said side door, said pinch protection sensor programmed to
detect whether said closing edge is gripped by a hand; and
suspend or relax a locking of said side door by said drive and/or said brake to permit said side door to be displaced manually.

13. A method of operating a pinch protection sensor being at least partly disposed on a closing edge of a side door of a motor vehicle, which comprises the steps of:
detecting whether the closing edge is gripped by a hand; and
suspending or relaxing a locking of a completely or partially open side door brought about by a drive and/or a brake upon detection of the hand gripping the closing edge so that the side door can be displaced manually.
